(19) United States
(12) Patent Application Publication
(10) Pub. No.: US 2003/0055938 A1
(43) Pub. Date: Mar. 20, 2003

(54) Method and apparatus for high-speed generation of a priority metric for queues

(76) Inventor: Ehud Barzilai, Beer Sheva (IL)

Correspondence Address: FITCH EVEN TABIN AND FLANNERY, 120 SOUTH LA SALLE STREET, SUITE 1600, CHICAGO, IL, 60603-3406, US

(21) Appl. No.: 10/203,719

(22) PCT Filed: Feb. 28, 2001
(86) PCT No.: PCT/IL01/00185

(30) Foreign Application Priority Data
Feb. 28, 2000 (IL) 134755

(51) Int. Cl. G06F 15/173

(52) U.S. Cl. 709/223

(57) ABSTRACT

A method and apparatus for establishing queue priorities for selecting one queue from at least two queues each containing items to be serviced, wherein a metric is determined for each queue by estimating the aggregate waiting time associated with all of the items in the respective queue, and the estimated aggregate waiting time is used to form a priority metric.

### FIELD OF THE INVENTION

The present invention relates to queuing systems. More particularly, the invention relates to a method and apparatus for real-time, efficient determination of queue priority in high-speed queuing systems.

### BACKGROUND OF THE INVENTION

Queuing systems are widespread in technical applications such as communication and computer systems. In a general queuing system, items requiring some sort of service arbitrarily arrive at the system and are grouped to form queues, where they await this service to be rendered by a server. Items in the queues are serviced according to a certain discipline, such as First-In-First-Out (FIFO) or Last-In-First-Out (LIFO), with FIFO being the prevalent service discipline. When an item is served, it is said to have ‘departed’ from the queue and is no longer tracked by the queuing system.

In many applications, there are fewer servers than queues, and a scheduling discipline must be employed to determine which queue is to be served first by an available server.

The goal of most scheduling disciplines is to achieve maximum utilization of system resources (servers) while maintaining at least a desired minimal level for the Quality-of-Service (QoS) experienced by queued items. The QoS is usually measured by several main parameters: (1) Mean service delay—the average amount of time that an item is expected to wait from arrival at the queue until it is served. (2) Delay variation—the variation of the delay among items. (3) Mean queue occupancy—the average number of items expected to be in a queue. (4) ‘Loss probability’ or ‘blocking probability’—the probability of an item to arrive at a queue that cannot accommodate it, and thus be ‘blocked’ or ‘lost’.

In order to achieve the required goal, many scheduling disciplines make use of a priority metric assigned to each queue. Higher priority queues are usually more likely to be served before lower priority ones. The method used to determine the priority value for queues can thus greatly affect the overall performance of any scheduling discipline that employs priority metrics.

Several priority-generating mechanisms (PGMs) have been proposed for determining queue priority. The most common is QO (queue occupancy) whereby the priority is directly proportional to the queue occupancy (number of items in the queue). Accordingly, the longest queue always holds the highest priority. When deploying a QO-based scheduling discipline, a queue to which very few items have arrived may be left unserved (“starved”) for a prolonged duration, resulting in long service delays.

Another proposed mechanism is the OIA (oldest item age) whereby the priority is proportional to the waiting time of the oldest item in the queue. Although this technique does not suffer from the starvation phenomenon, it does not directly take into account the queue occupancy or the waiting time of items other than the one at the head of the queue. In addition, in order to implement OIA, a timer (counter) must be associated with each item in the queue from the moment it arrives until its departure. The hardware requirements for the implementation of a system based on such an approach render OIA infeasible for most practical implementations.

In order for the priority value to represent accurately the queue's status it must express several queuing parameters such as the occupancy, average waiting time and QoS preference. In addition, for practical reasons, such priority determining algorithms should have minimum complexity, in order to necessitate as little hardware as possible, and to complete the calculation in as little time as possible. As mentioned above, the role of the priority generating mechanism is significant since it constitutes the foundation for the scheduling system, thus directly affecting its performance.

To maintain scheduling fairness, it is necessary that an identical priority generating mechanism be applied to all queues. Despite this requirement for fairness, it is sometimes desirable to give inherent service preference to specific queues over other queues.

In some scheduling schemes and applications, upon assignment of a server to a queue, several items are serviced consecutively as opposed to servicing only a single item per server-queue assignment. A compromise between service resolution (number of items served per assignment) and scheduling complexity is practiced in the prior art. An efficient PGM is required to handle such scenarios.

Methods presented in the past have not yet provided satisfactory solutions to the problem of providing a fair, real-time, scalable, and pragmatically implemented PGM that can support QoS provisioning in high-speed queuing systems.

### SUMMARY OF THE INVENTION

It is an object of the present invention to provide a method and apparatus for generating queue-priority values in high-speed queuing systems, wherein the aforementioned drawbacks are reduced or eliminated.

It is another object of the invention to provide a method and apparatus for generating queue-priority values in real-time for high-speed queuing systems.

It is yet another object of the invention to provide a method and apparatus for generating queue-priority values in queuing systems, which provides a solid expression of statistical queuing metrics such as queue occupancy, average waiting time and prescribed QoS preference values.

Other objects and advantages of the invention will become apparent from the following description of a preferred embodiment.

According to a broad aspect of the invention, there is provided a method for establishing a queue priority for selecting one queue from at least two queues each containing items to be serviced, said method comprising the steps of:

(a) determining for each queue an estimated aggregate waiting time (EAWT) associated with all of the items in the respective queue, and

(b) using the estimated aggregate waiting time to form a priority metric.

The present invention is directed to a method for real-time generation of priority values for each of a multiplicity of queues, each containing zero or more items waiting for service. One or more servers serve items in each of the queues. The invention is further directed to an implementation scheme based on estimating the aggregated waiting time of the items in each queue. Since the mechanism is applied to all queues in a similar manner, the description and analysis may be carried out for a single queue, independent of the structure of the whole queuing system. Using the proposed priority generating mechanism, the system may optimally utilize its resources (i.e. the servers) while complying with QoS requirements.

In the invention, the queue priority value is defined as a function combining the estimated aggregate waiting time (EAWT) of items in the queue with a predefined (or slowly changing) parameter assigned to the queue, named ‘QoS-class’. The result encapsulates expressions for queue occupancy, item waiting time and the QoS-class parameter. According to a preferred embodiment of the invention, such a technique is based on the assumption that the inter-arrival time is locally stationary or, in other words, that the duration between the respective arrivals of successive items found in the queue at any given time is close to a constant. As opposed to common schemes, such as OIA, the invention does not require a timer or counter to be associated with each item in the queue.

An efficient approximate algorithm for the invention is provided that makes two further assumptions and facilitates simple, fast hardware implementations.

The invention is also directed to an apparatus for real-time queue priority generation, comprising circuitry for determining the priority value according to statistical queuing information.

### BRIEF DESCRIPTION OF THE DRAWINGS

The above and other characteristics and advantages of the invention will be better understood through the following illustrative and non-limiting example of some preferred embodiments thereof, with reference to the appended drawings, wherein:

FIG. 1 is an illustration of a basic FIFO queuing system;

FIG. 2 is a block diagram showing functionally a priority generating mechanism according to a preferred embodiment of the invention; and

FIG. 3 is a flowchart of the algorithm underlying the priority generating mechanism shown in FIG. 2.

### DETAILED DESCRIPTION OF THE INVENTION

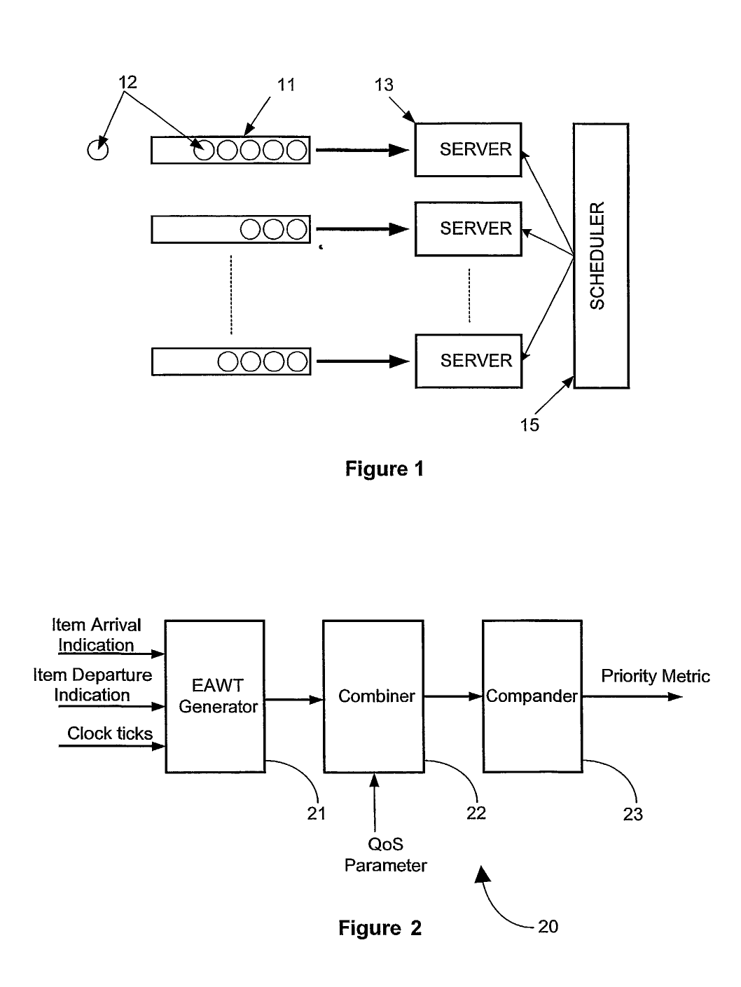

FIG. 1 illustrates a queuing system 10 having one or more queues 11 each employing the First-In-First-Out FIFO queuing discipline, where items 12 arrive at the queue 11 and depart from it upon being served by a server 13. The item arrival process is assumed arbitrary. The time an item waits until it departs from the queue directly relates to the specific queue service statistics characterizing the system. Many scheduling schemes may be applied to determine which queue is to be served by available servers, each scheme directly influencing the item departure statistics.

In an effort to provide higher priority to queues with items waiting for service longer than others, a measurement of the aggregate item waiting time is determined. As mentioned earlier, in order to calculate the aggregate item waiting time accurately, a timer (counter) must be assigned to each item in the queue as means of tracking the amount of time by which it is delayed. This, however, is infeasible in many practical situations since a counter per item imposes impracticable hardware requirements, especially when long queues are to be maintained. It is a goal of the invention to provide an estimated metric of the aggregate waiting time of items in the queue using moderate hardware requirements, regardless of queue length.

It is common practice in some systems to serve several items in a batch from the same queue whenever a server is assigned to serve the queue. According to the preferred embodiment of the invention, a time slot denotes the duration of time in which a server is assigned to serve a particular queue. This duration is measured in units of the period between the occurrence of a periodic event called a clock tick. The period between clock ticks may be chosen arbitrarily. Clock ticks are usually provided to the system in the form of a periodic clock signal. Clock ticks are also used as units for the measurement of the waiting time of items in the queue.

The duration of a time slot can be fixed or variable, and may be chosen arbitrarily by the queuing system designer. The only limitation imposed on the time slot duration is that a server may not begin to serve the queue during the period of a time slot, nor can a server serving the queue cease to serve it during this period.

In this preferred embodiment, the Estimated Aggregate Waiting Time (EAWT) is computed for a queue priority calculation at the end of each time-slot. EAWT is an estimate of the sum of waiting times (from arrival until the moment of calculation), in clock ticks, of all items in the queue.

To facilitate the calculation of the EAWT, an assumption is made that the inter-arrival time of items, denoted by Δt, is locally stationary. In other words, at any given time, the Δt between the arrival of any two adjacent items in the queue is roughly constant for all items currently in the queue. Under this assumption an estimation of the EAWT is achieved by employing the following rules:

1. Let Wₜ represent the EAWT at time t, and nₜ—the number of items in the queue at time t. Whenever a clock tick occurs, every item in the queue is considered to have waited an additional unit of time, hence:

Wₜ=Wₜ₋₁+nₜ₋₁

2. At the end of a time slot, if k items have departed from the queue during the time slot then their contribution to the EAWT must be removed. Under the assumption of constant Δt, if there are n items in the queue, then the contribution of the oldest item to the EAWT is nΔt, the contribution of the next oldest item is (n−1)Δt, etc. Thus the EAWT is the sum of this assumed contribution of all items.

If there are n items in the queue at the end of a time slot, and k items have departed during the time slot, then there were n+k items in the queue at the beginning of the time slot (assuming no arrivals). The EAWT at the beginning of the time slot is therefore:

(n+k)Δt+(n+k−1)Δt . . . Δt=Sₙ₊ₖΔt.

while at the end it is:

nΔt+(n−1)Δt . . . Δt=SₙΔt.

defining

$${S}_{n} := \frac{n ( n + 1 )}{2}$$

Accordingly, the ratio between the EAWT at the end of the time-slot to the EAWT at the beginning of the time slot, denoted by Sₙ/Sₙ₊ₖ, allows for calculating the EAWT at the end of the time slot using the EAWT known at its beginning.

Utilizing this ratio, the EAWT is updated as follows:

$${W}_{t} = {W}_{t - TS} \frac{{S}_{n}}{{S}_{n + k}} = \frac{n ( n + 1 )}{( n + k ) ( n + k + 1 )}$$

Where TS denotes the duration of the time-slot.

In order to incorporate the QoS preference, Wₜ can be combined with the QoS class parameter associated with the queue using any mathematical function such as multiplication, addition, exponentiation etc. The differentiation between queues using the QoS class parameter may vary in accordance with the application.

Finally, a companding function (monotonic mapping transform) may be applied to the value obtained to limit the dynamic range of the priority values generated.

FIG. 2 is a block diagram showing functionally a priority generating mechanism depicted generally as 20 and comprising an EAWT generator 21 responsive to indications of item arrival and departure and clock ticks for determining the Estimated Aggregate Waiting Time, as described above. The EAWT generator 21 is coupled to a Combiner 22, which combines the EAWT with a QoS parameter. The combined function is fed to a compander 23, whose output is the desired priority metric.

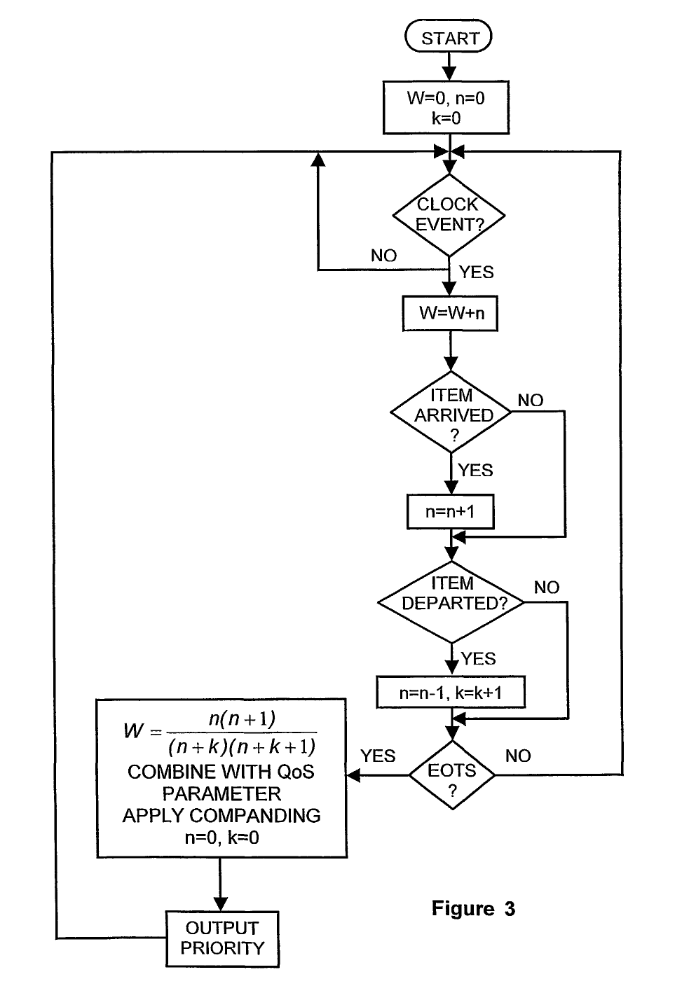

FIG. 3 illustrates a flowchart of the algorithm for the priority generating mechanism.

Implementation of the procedure described above necessitates two calculations:

1. Sₙ/Sₙ₊ₖ

2. Multiplication of Sₙ/Sₙ₊ₖ by W_{t-TS}

The above calculations may be too complicated for certain applications requiring very high-speed computation of EAWT. In such applications it is possible to make further assumptions in order simplify the calculations. Efficient calculation of Sₙ/Sₙ₊ₖ for hardware implementations may be obtained using the following arithmetic elaboration:

$${( \frac{{S}_{n}}{{S}_{n + k}} )}^{- 1} = \frac{( n + k ) ( n + k + 1 )}{n ( n + 1 )} = 1 + \frac{k}{n} + \frac{k}{n + 1} + \frac{{k}^{2}}{n ( n + 1 )}$$

Assuming n>>k>>1

$${( \frac{{S}_{n}}{{S}_{n + k}} )}^{- 1} \approx 1 + \frac{2 k}{n}$$

$$and hence \text{:}$$

$$\frac{{S}_{n}}{{S}_{n + k}} \approx \frac{n}{n + 2 k}$$

Since the above assumptions are not always true, a correction function α(n, k) may be added in the following manner:

$$\frac{{S}_{n}}{{S}_{n + k}} = \frac{n + α ( n , k )}{n + 2 k}$$

The α(n, k) values may be extracted from a lookup table for gaining speed. This is applied mainly in cases where the assumption n>>k>>1 does not necessarily hold.

The following are the main advantages of the proposed approximation technique:

Calculation time may be substantially shortened, by mailing the n>>k>>1 assumption, to an addition operation and a division. Multiplying the approximated ratio with the previous EAWT value attains an EAWT update.

Under the above assumption, quite good accuracy is achieved by adding a constant term, without imposing further delay on the calculation time since it is performed concurrently to the other addition operation.

The invention is also directed, though not in a limited way, to an apparatus for generating real-time priority metric for use in queuing systems.

The apparatus consists of an efficient approximation to the aggregate waiting time of items in FIFO-type queues, where the priority directly relates to the approximate aggregate waiting time and to the number of items in the queue, combined with a QoS-class parameter as described above.

It will also be understood that the apparatus according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Finally, it should be noted that, whilst the method and apparatus according to the invention have been described with regard to servicing queues in general, a particular application is in the field of communication networks. For example, the method may be used to assign queue priorities in the high-speed, high-capacity packet-scheduling network described in our co-pending Israeli patent application no. 132694 filed on Nov. 1, 1999 and entitled “Method and apparatus for high-speed, high-capacity packet-scheduling supporting quality of service in communications networks”.

1. A method for establishing queue priorities for selecting one queue from at least two queues each containing items to be serviced, said method comprising the steps of:
(a) determining for each queue a metric by estimating the aggregate waiting time associated with all of the items in the respective queue, and
(b) using the estimated aggregate waiting time to form a priority metric.

2. The method according to claim 1, wherein each queue is dedicated for a respective Quality of Service (QoS) and step (b) includes:
i) combining the estimated aggregate waiting time with a parameter determined by the QoS for which the queue is dedicated.

3. The method according to claim 1 or 2, wherein at least one of said queues is served by a multi-item server adapted to service, concurrently or serially, a batch containing more than one item and the priority metric is calculated only at the beginning or end of each batch.

4. The method according to any one of the preceding claims, wherein an inter-arrival time Δt of items at each of said queues is assumed to be locally stationary in order to facilitate the calculation of the aggregate waiting time.

5. The method according to claim 4, wherein the aggregate waiting time is calculated as:
$$EAWT ( t + 1 ) = \frac{n ( n + 1 )}{( n + k ) ( n + k + 1 )} \cdot EAWT ( t )$$
where:
n=the number of items in the queue,
k=the number of items in the queue which depart during a time slot, and
t=time, counted in time-slots (i.e. a time-slot's index).

6. The method according to claim 5, further including the steps of assuming that n>>k>>1 and calculating:
$${( \frac{{S}_{n}}{{S}_{n + k}} )}^{- 1} \approx 1 + \frac{2 k}{n}$$
where:
Sₙ/Sₙ₊ₖ=the ratio between the EAWT at the end of the time-slot to the EAWT at the beginning of the time slot;
thereby allowing simple computation the EAWT at the end of a time slot from its value at the beginning of the time slot.

7. The method according to any one the preceding claims, further including:
applying a companding function to the value obtained as queue priority, in order to limit the dynamic range of the priority values generated.

8. Use of the method according to any one the preceding claims for establishing queue priorities in a communication network switch.

9. An apparatus for establishing queue priorities for selecting one queue from at least two queues each containing items to be serviced, said apparatus comprising:
a computer for determining for each queue an estimated aggregate waiting time (EAWT) associated with all of the items in the respective queue, and using the estimated aggregate waiting time to form a priority metric.

10. The apparatus according to claim 9, wherein each queue is dedicated for a respective Quality of Service (QoS) and the computer is adapted to combine the estimated aggregate waiting time with a parameter determined by the QoS for which the queue is dedicated.

11. The apparatus according to claim 9 or 10, wherein at least one of said queues is served by a multi-item server adapted to service, concurrently or serially, a batch containing more than one item and the priority metric is calculated only at the beginning or end of each batch.

12. The apparatus according to any one of claims 9 to 11, wherein an inter-arrival time Δt of items at each of said queues is assumed to be locally stationary.

13. The apparatus according to claim 12, wherein the computer calculates the aggregate waiting time as:
$$EAWT ( t + 1 ) = \frac{n ( n + 1 )}{( n + k ) ( n + k + 1 )} \cdot EAWT ( t )$$
where:
n=the number of items in the queue,
k=the numbers of items in the queue which depart during a time slot, and
t=time, counted in time-slots (i.e. a time-slot's index).

14. The apparatus according to claim 13, where it is assumed that n>>k>>1 and the computer is adapted to calculate:
$${( \frac{{S}_{n}}{{S}_{n + k}} )}^{- 1} \approx 1 + \frac{2 k}{n}$$
where:
Sₙ/Sₙ₊ₖ=the ratio between the EAWT at the end of the time-slot to the EAWT at the beginning of the time slot;
thereby allowing simple computation the EAWT at the end of a time slot from its value at the beginning of the time slot.

15. The apparatus according to any one claims 9 to 14, wherein the computer is further adapted to apply a companding function to the value obtained to limit a dynamic range of the priority values generated.

16. A program storage device readable by machine, tangibly embodying a program of instructions executable by the machine to perform method steps for establishing a queue priority for selecting one queue from at least two queues each containing items to be serviced, said method comprising the steps of:
(a) determining for each queue an estimated aggregate waiting time (EAWT) associated with all of the items in the respective queue, and
(b) using the estimated aggregate waiting time to form a priority metric.

17. A computer program product comprising a computer useable medium having computer readable program code embodied therein for establishing a queue priority for selecting one queue from at least two queues each containing items to be serviced, said computer program product comprising:
computer readable program code for causing the computer to determine for each queue an estimated aggregate waiting time (EAWT) associated with all of the items in the respective queue, and
computer readable program code for causing the computer to use the estimated aggregate waiting time to form a priority metric.
